(19) United States
(12) Patent Application Publication
(10) Pub. No.: US 2002/0136287 A1
(43) Pub. Date: Sep. 26, 2002

(54) Method, system and apparatus for displaying the quality of data transmissions in a wireless communication system

(76) Inventors: Robert W. Heath, Mountain View, CA (US); Peroor K. Sebastian, New Delhi (IN)

Correspondence Address: Patent Department, Iospan Wireless, P.O. Box 641867, San Jose, CA, 95164-1867, US

(21) Appl. No.: 09/813,656

(22) Filed: Mar. 20, 2001

(51) Int. Cl. H04B 17/00; H04Q 1/20; H04L 1/02

(52) U.S. Cl. 375/228; 375/227; 375/259; 375/347; 455/272

(57) ABSTRACT

A first embodiment of the present invention is a method for displaying the quality of a wireless data transmission. The method involves receiving the wireless data transmission wherein the wireless data transmission comprises multiple streams of data, determining the quality of the wireless data transmission based on a quality parameter of the wireless data transmission and displaying the quality of the wireless data transmission. A second embodiment of the present invention includes an apparatus for indicating the quality of a wireless data transmission. The apparatus includes means for receiving the wireless data transmission wherein the wireless data transmission comprises multiple streams of data, means for determining the quality of the wireless data transmission based on a quality parameter of the wireless data transmission and means for displaying the quality of the wireless data transmission. A third embodiment of the present invention includes a wireless communication system. The wireless communication system includes a base transceiver station wherein the base transceiver station implements a spatial multiplexing transmission technology, means for receiving a wireless data transmission from the base transceiver station, means for determining a quality of the wireless data transmission based on a quality parameter of the wireless data transmission and means for displaying the quality of the wireless data transmission.

### FIELD OF THE INVENTION

This invention relates generally to wireless communication systems. More particularly the invention relates to a method, system and apparatus for displaying the quality of data transmissions in a wireless communication system.

### BACKGROUND OF THE INVENTION

Wireless communication systems typically include information carrying modulated carrier signals that are wirelessly transmitted from a transmission source (for example, a base transceiver station (BTS)) to one or more receivers (for example, subscriber units) within an area or region.

Conventional wireless communication systems attempt to share the wireless medium among different users by using multiple access schemes, the most common being frequency-division multiple access (FDMA), time-division multiple access (TDMA), and code-division multiple access (CDMA). All current systems employ FDMA, wherein the available frequency bandwith is sliced into multiple frequency channels and signals are transmitted over the different channels simultaneously.

The subscriber unit is typically provided with a quality indicator which describes the quality/strength of the received signal. For example, cellular phones typically use an LED with a series of bars to indicate some measure of quality such as received power, signal-to-noise ratio, carrier-to-noise ratio, or signal-to-interference plus noise ratio.

### Spatial Multiplexing

A recent advance in wireless communications systems introduces a novel modulation scheme known as spatial multiplexing. Spatial multiplexing is a transmission technology that exploits multiple antennae at both the base transceiver station and at the subscriber units to increase the bit rate in a wireless radio link with no additional power or bandwidth consumption. Data substreams are applied separately to the transmit antennae and transmitted through a radio channel. Under certain conditions, spatial multiplexing offers a linear increase in spectrum efficiency with the number of antennae. The substreams occupy the same channel of a multiple access protocol, the same time slot in a time-division multiple access protocol, the same frequency slot in frequency-division multiple access protocol, the same code sequence in code-division multiple access protocol or the same spatial target location in space-division multiple access protocol. Due to the presence of various scattering objects in the environment, each signal experiences multipath propagation.

The composite signals resulting from the transmission are finally captured by an array of receiving antennae with random phase and amplitudes. At the subscriber array, a spatial signature of each of the received signals is estimated. Based on the spatial signatures, a signal processing technique is applied to separate the signals thereby recovering the original substreams.

FIG. 1 shows three transmitter antenna arrays 110, 120, 130. The transmitter antenna arrays 110, 120, 130 transmit data symbols to a subscriber antenna array 140. Each transmitter antenna array includes spatially separate antennae. A subscriber connected to the subscriber antenna array 140 then separates the received signals.

Multipath can include a composition of a primary signal plus duplicate or echoed images caused by reflections of signals off objects between the transmitter and subscriber. The subscriber may receive the primary signal sent by the transmitter, but also receives secondary signals that are reflected off objects located in the signal path. The reflected signals may arrive at the subscriber later than the primary signal. Due to this misalignment, the multipath signals can cause intersymbol interference or fading of the received signal.

FIG. 2 shows modulated carrier signals traveling from a transmitter 210 to a subscriber 220 following multiple transmission paths.

### Communication Diversity

Antenna diversity is a technique used in multiple antenna-based communication system to reduce the effects of multi-path fading. Antenna diversity can be obtained by providing a transmitter and/or subscriber with two or more antennae. These multiple antennae imply multiple channels that suffer from fading in a statistically independent manner. Therefore, when one channel is fading due to the destructive effects of multi-path interference, another of the channel is unlikely to be suffering from fading simultaneously. By virtue of the redundancy provided by theses independent channels, a subscriber can often reduce the detrimental effects of fading.

The previously described spatial multiplexing and communication diversity each employ multiple antennae to improve the transmission link between a base station and a subscriber unit. Unfortunately, existing quality indicators are not equipped to account for the presence of multiple transmit antennae. Accordingly, what is needed is a quality indicator that is suitable for use in a multiple data stream/multipath environment. The present invention addresses such a need.

### SUMMARY OF THE INVENTION

The present invention comprises a method, system and apparatus for displaying the quality of wireless data transmissions in a wireless communication system. The method, system and apparatus display information related to the link quality of a wireless data transmission wherein the wireless data transmission is transmitted via multiple transmit antennae. Based on the link quality information, a system user can quickly and easily adjust system settings in order to attain optimal link quality.

A first embodiment of the present invention is a method for displaying the quality of a wireless data transmission. The method involves receiving the wireless data transmission wherein the wireless data transmission originates from multiple transmit antennae, determining the quality of the wireless data transmission based on a quality parameter of the wireless data transmission and displaying the quality of the wireless data transmission.

A second embodiment of the present invention is a method for displaying the quality of a wireless data transmission. The method involves receiving the wireless data transmission wherein the wireless data transmission originates from a communication system comprising multiple transmit antennae and multiple receive antennae, determining the quality of the wireless data transmission based on a quality parameter of the wireless data transmission and displaying the quality of the wireless data transmission.

A third embodiment of the present invention is a method for displaying the quality of a wireless data transmission. The method involves receiving the wireless data transmission wherein the wireless data transmission originates from a spatial multiplexing system, determining the quality of the wireless data transmission based on a quality parameter of the wireless data transmission and displaying the quality of the wireless data transmission.

A fourth embodiment of the present invention includes an apparatus for indicating the quality of a wireless data transmission. The apparatus includes means for receiving the wireless data transmission wherein the wireless data transmission comprises multiple streams of data, means for determining the quality of the wireless data transmission based on a quality parameter of the wireless data transmission and means for displaying the quality of the wireless data transmission.

A fifth embodiment of the present invention includes a wireless communication system. The wireless communication system includes a base transceiver station wherein the base transceiver station implements a spatial multiplexing transmission technology, means for receiving a wireless data transmission from the base transceiver station, means for determining a quality of the wireless data transmission based on a quality parameter of the wireless data transmission and means for displaying the quality of the wireless data transmission.

Other aspects and advantages of the present invention will become apparent from the following detailed description, taken in conjunction with the accompanying drawings, illustrating by way of example the principles of the invention.

### BRIEF DESCRIPTION OF DRAWINGS

FIG. 1 shows a conventional wireless communication system.

FIG. 2 shows modulated carrier signals traveling from a transmitter to a subscriber following multiple transmission paths.

FIG. 3 shows a flowchart of the method in accordance with the present invention.

FIG. 4A is an illustration of a system in accordance with the present invention.

FIG. 4B is an example of a modulation scheme in accordance with the present invention.

FIG. 5 is a block diagram of the system in accordance with the present invention.

FIG. 6 is a more detailed flowchart of the method in accordance with the present invention.

FIG. 7 is an illustration of a single input display unit.

FIG. 8 is an illustration of a multiple input display unit.

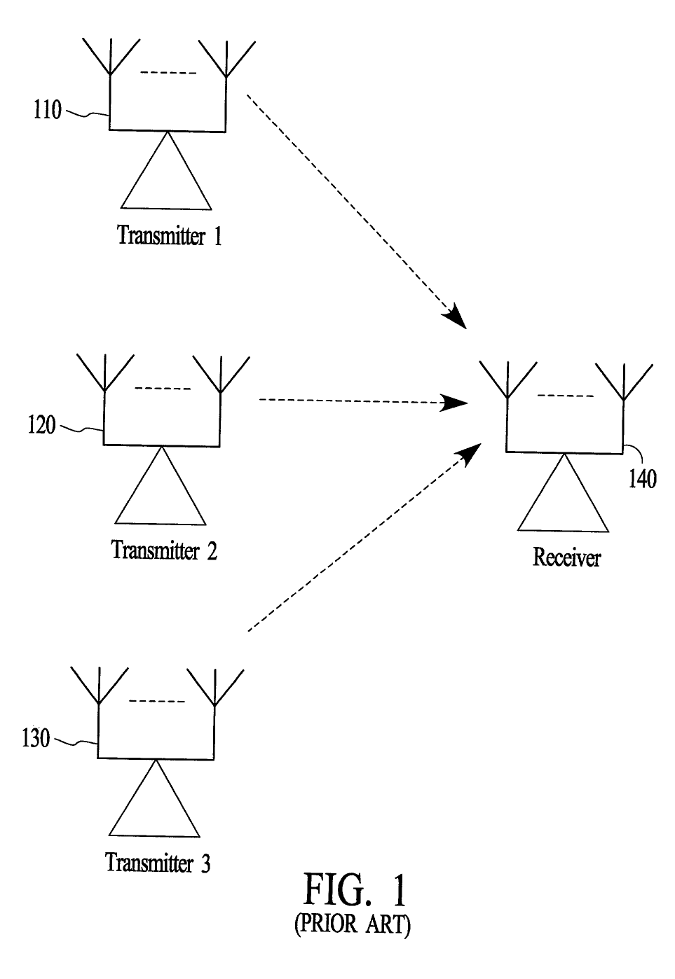

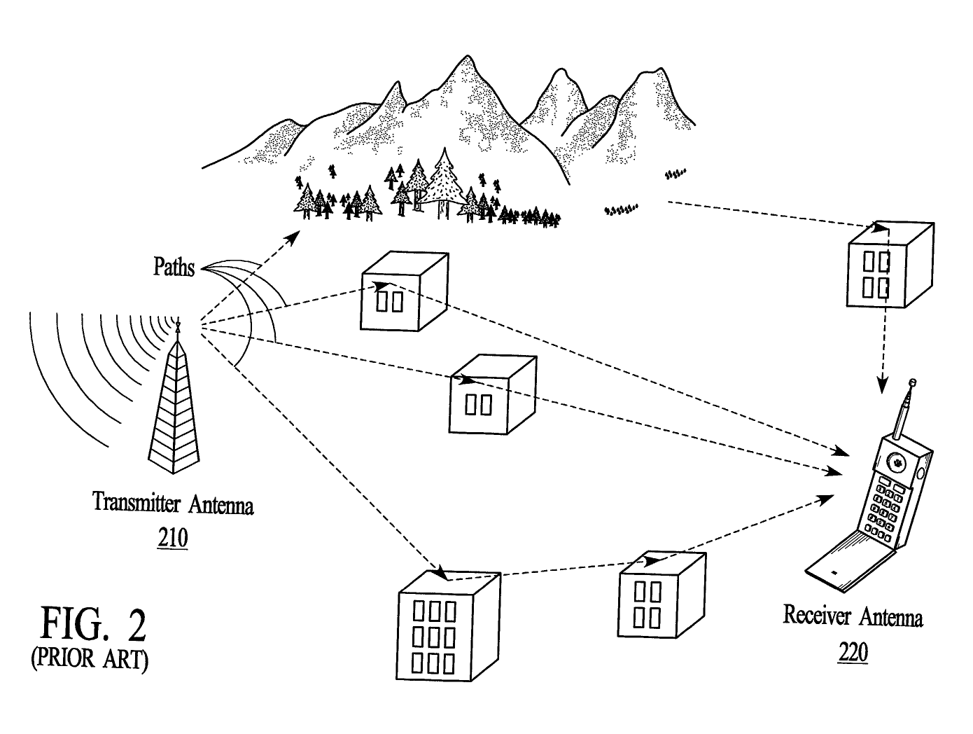

### DETAILED DESCRIPTION OF THE INVENTION

The present invention relates to a method, system and apparatus for displaying the quality of wireless data transmissions in a wireless communication system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

As previously mentioned, the present invention comprises a method, system and apparatus for displaying the quality of wireless data transmissions in a wireless communication system. The method and system displays information related to the link quality of a wireless data transmission wherein the wireless data is transmitted via multiple transmit antennae. Based on the link quality information, a system user can quickly and easily adjust system settings in order to attain optimal link quality.

The invention includes wireless communication between at least one base transceiver station and subscriber (receiver) units. The communication is two-way. That is, information is transmitted from the base transceiver station to the receiver units (down link transmission), and information is transmitted from the receiver units to the base transceiver station (up link transmission).

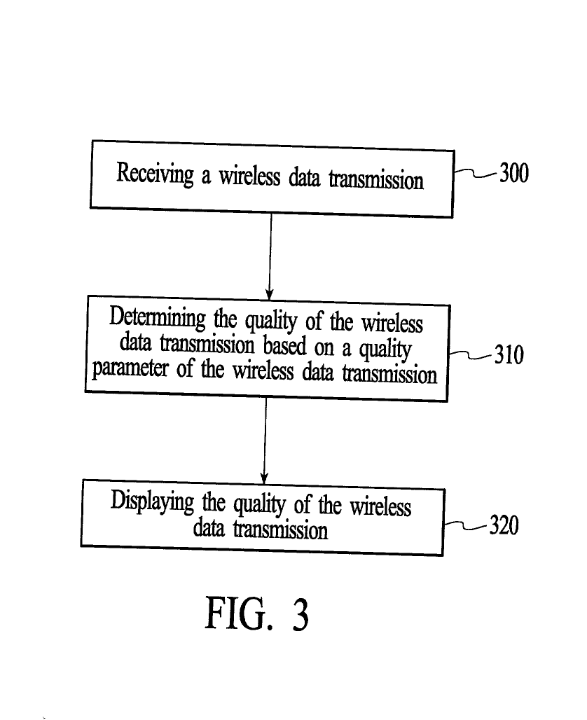

For a farther understanding of the present invention, please refer to FIG. 3. FIG. 3 is a high level flowchart of the method in accordance with the present invention. First, a wireless data transmission is received, via step 300. Preferably, the wireless data transmission is transmitted via multiple transmit antennae. Next, the quality of the wireless data transmission is determined based on a quality parameter of the wireless data transmission, via step 310. Finally, the quality of the wireless data transmission is displayed, via step 320.

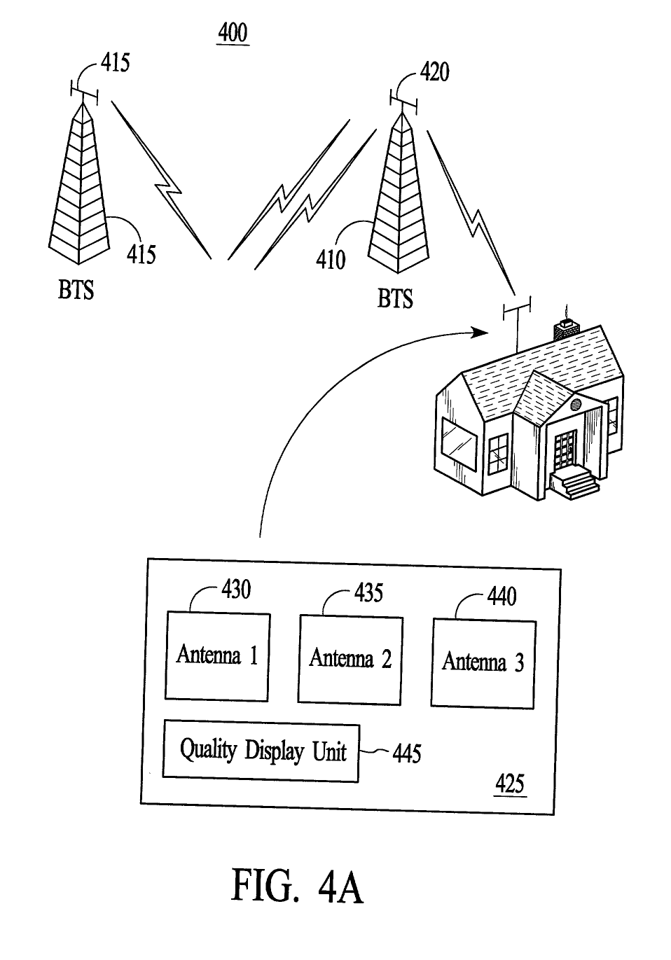

For a further illustration of a system in accordance with the present invention, please refer to FIG. 4A. FIG. 4A shows a system 400 in accordance with the present invention. The system 400 includes base transceiver stations 405, 410 wherein each base transceiver station 405, 410 includes multiple transmit antennae 415, 420. The system 400 further includes a receive unit 425 comprising a plurality of receive antennae 430, 435, 440, and a quality display unit 445.

The above-described system is illustrative of a down link transmission. However, one of ordinary skill in the art will readily recognize that the system in accordance with the present invention is also applicable to an up link transmission.

As previously mentioned, the present invention preferably implements a modulation scheme employing multiple transmit antennae. In this type of modulation scheme, the data is mapped into multiple data streams for transmission via multiple transmit antennae. The data substreams are then transmitted to at least one receive antennae via a radio channel.

For a further illustration of this type of modulation scheme, see FIG. 4B. FIG. 4B shows a space-time modulator 450, training data 455, and multiple antennae 460, 465. The space-time modulator 450 maps outgoing data along with the training data 455 into multiple data streams for transmission via the multiple transmit antennae 460, 465.

The quality of the transmission of these data substreams has several associated parameters. These quality parameters include, but are not limited to, the signal-to-noise ratio, carrier-to-interference ratio, signal-to-interference plus noise ratio, bit error rate, packet error rate, frame error rate, and the cyclic redundancy check failure rate. Consequently, the quality of the transmission of the data substreams can be determined based on the value of one or more of these quality parameters.

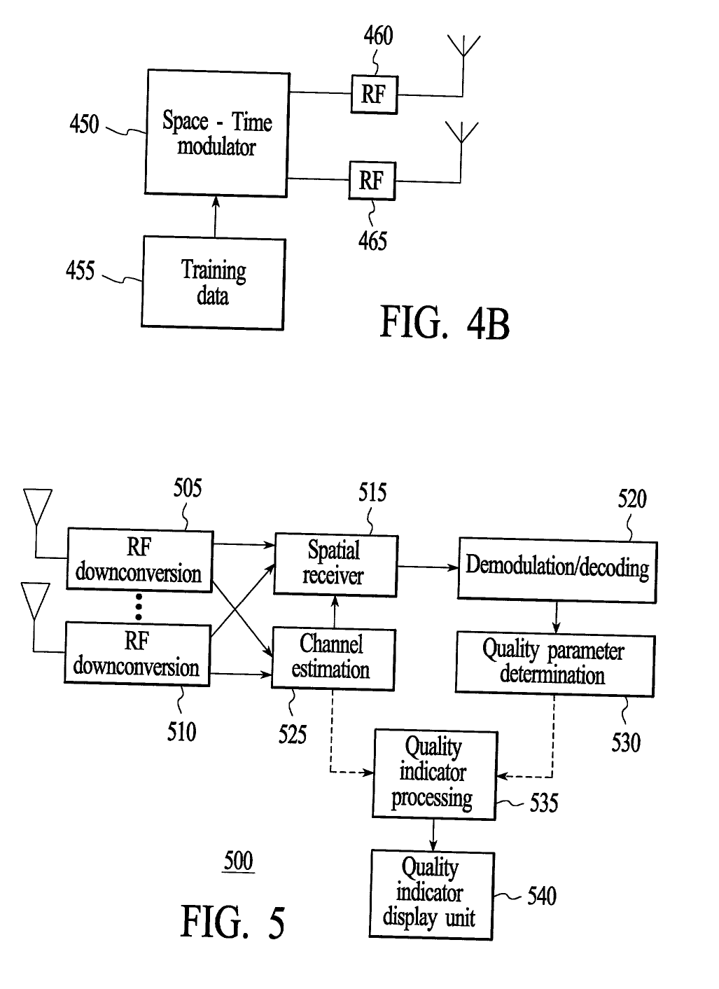

For a further understanding of the system in accordance with the present invention, please refer now to FIG. 5. FIG. 5 is a block diagram of the system 500 in accordance with the present invention. The system 500 comprises two radio frequency down-conversion blocks 505, 510, a spatial receiver block 515, a demodulation/decoding block 520, a channel estimation block 525, an quality parameter determination block 530, a quality indicator processing block 535, and a quality indicator display unit 540.

The radio frequency down-conversion blocks 505, 510 amplify and convert the received signals and perform any other required operations (e.g. sampling, analog-to-digital conversion) then passes the signals to the spatial receiver block 515 and passes the channel training data to the channel estimation block 525. The channel estimation block then passes the channel estimates to the spatial receiver block 515 and the signals are passed from the spatial receiver block to the demodulation/decoding block 520. The demodulation/decoding block 520 then decodes the received signals and passes them to the quality parameter determination block 530.

The channel estimation block 525 computes the channel estimates for the received signals and passes the estimates to the quality indicator processing block 535. The quality indicator processing block 535 then processes the information received by the channel estimation block 525 and the quality parameter determination block 530 and a quality of the received signals is determined. The quality can be determined based on information from the channel estimation block 525 or from the quality parameter determination block 530 or from a combination thereof. The quality of the received signals is then passed on to the quality indicator display unit 540 where the quality of the received signal(s) is then displayed to the end user.

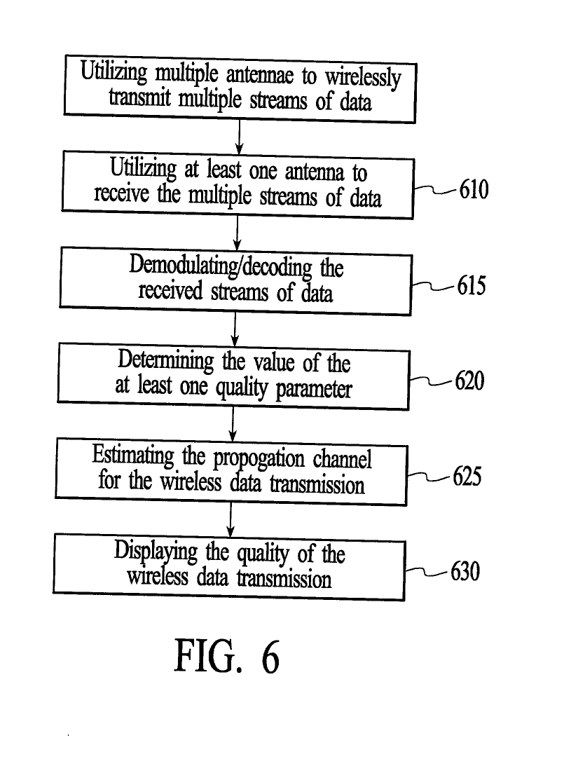

For a better understanding of the present invention, please refer to FIG. 6. FIG. 6 is a more detailed flowchart 600 of the method in accordance with the present invention. First, multiple transmit antennae are utilized to wirelessly transmit multiple streams of data, via step 605. Next, at least one antenna is utilized to receive the multiple streams of data, via step 610. Preferably, multiple antennae are utilized to receive the multiple streams of data. The multiple streams of data are then demodulated/decoded, via step 615.

Next, the value of at least one quality parameter is determined, via step 620. Preferably, the quality parameter comprises one of the following: the signal-to-noise ratio, carrier-to-interference ratio, signal-to-interference plus noise ratio, bit error rate, packet error rate, frame error rate, or the cyclic redundancy check failure rate. The propagation channel of the wireless data transmission is then estimated, via step 625. Finally, the quality of the wireless data transmission is displayed, via step 630.

### Propogation Channel Estimation

Two meanings of the word “channel” are commonly used when discussing wireless systems. The first definition describes the frequency slot, time slot, and code in FDMA, TDMA, and CDMA systems, respectively. The word “channel” also describes the path between a transmitter and a receiver. Accordingly, transmission signals propogate through a channel when the base transceiver station communicates with a remote transceiver. In general, channels can include line-of-sight paths as well as one or more reflected paths.

The time variation of the transmission channel causes transmitted signals to experience fluctuating levels of attenuation, interference, multi-path fading and other deleterious effects. Therefore, quality parameters such as data capacity or throughput undergo temporal changes. Thus, the channel can not at all times support efficient propogation of high data rate signals or signals which are not formatted with a robust coding algorithm.

Propogation channel estimation involves estimating the channel coefficients using known training patterns in accordance with known techniques. In the present case, the channel estimate is calculated according to the following relationship:

Y=HS+V

Here, Y is the matrix of received data, H is the channel estimate, S is a matrix of pure channel coefficients, and V is a noise matrix. Y, S and V are all known quantities so the channel estimate H is calculated as:

H=Y/S−V

The channel estimates are supplied to the quality indicator processing block 535 and can be used to assess the quality of the wireless data transmission as a function of the channel estimates, i.e. channel condition number, delay spread, time/frequency variance, etc.

Although the channel estimate can be calculated using the above-described equation, one of ordinary skill in the art will readily recognize that the channel estimate can be calculated in a variety of ways while remaining within the spirit and scope of the present invention.

### Quality Parameter Determination

Preferably, the quality parameter determination block 530 comprises a statistical unit that analyzes the received streams of data and determines values for one or more quality parameters. The unit is preferably an averaging unit which averages signal/error rate statistics over time. For example, the signal statistics could relate to the signal-to-noise ratio, carrier-to-interference ratio, and the signal-to-interference plus noise ratio while the error rate statistics could relate to the bit error rate, the packet error rate, the frame error rate and the number of cyclic redundancy check failures.

Although the above-described quality parameters are disclosed, one of ordinary skill in the art will readily recognize that a variety of quality parameters could be utilized, such as data capacity, throughput, etc. while remaining within the spirit and scope of the present invention.

### Quality Indicator Processing

The quality indicator processing block 535 receives the channel estimates from the channel estimation block 525 and the value of the quality parameter(s) from the quality parameter determination block 530. The quality indicator processing block 535 then assess the quality of the wireless transmission based on these inputs.

The quality of the wireless data transmission can be assessed based on the value of one or more of the quality parameters. For example, a particular scalar value for the bit error rate is associated with a quality of the wireless data transmission (i.e. lower bit error rate=higher quality, higher bit error rate=lower quality). Alternatively, the value of one or more of the quality parameters can be evaluated based on the calculated channel estimates.

Once this information is processed, it is forwarded to the quality indicator display unit 540 where the quality of the received signal(s) is displayed to the end user. The quality indicator processing block 535 may have a single output or multiple outputs. A single output is used in order to display some aggregate performance measure about the multiple data substreams whereas multiple outputs are used in order to display quality parameter values per substream or for multiple types of quality parameters.

### Quality Indicator Display Unit

The quality indicator display unit 540 receives the quality information from the quality processing block 535 and displays the quality of the wireless data transmission based on the received information. As previously stated, the quality indicator processing block 535 may have a single output or multiple outputs. Consequently, several display implementations are contemplated.

For example, in a single output implementation, the information displayed could be an aggregate value of a quality parameter for all of the data substreams. This value could be a minimum value, e.g. the minimum bit error rate of all of the data substreams, or an average value, e.g. the average received signal-to-noise ratio of all of the data substreams.

Alternatively, the information displayed with a single output could be some function of the channel estimate e.g., condition number, delay spread, time/frequency variance, etc. Note that the processing might include some sort of filtering or averaging across time as well as space. For example, the average minimum signal-to-interference plus noise ratio (average in time, minimum in space) or the average signal-to-interference plus noise ratio (average in time, average in space) could be displayed in a single output implementation. Furthermore, the single output could be an aggregate of some function of the channel estimate and a data quality parameter.

Multiple output implementations include displaying the quality parameter value for each data substream, e.g. displaying the packet error rate of each data substream or displaying multiple average statistics, e.g. displaying the average bit error rate, packet error rate, and signal-to-interference plus noise ratio for all of the data substreams, or displaying a channel quality parameter and a data quality parameter for the data substreams.

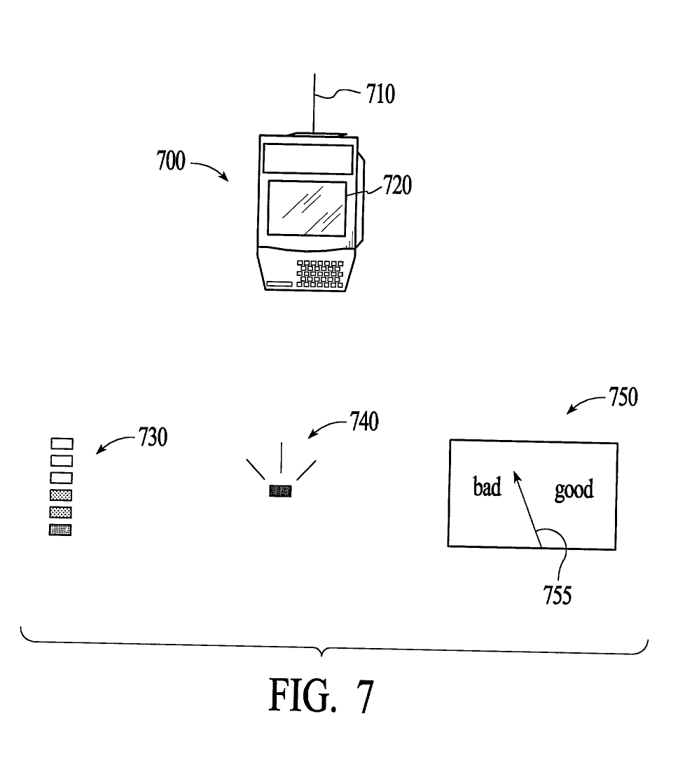

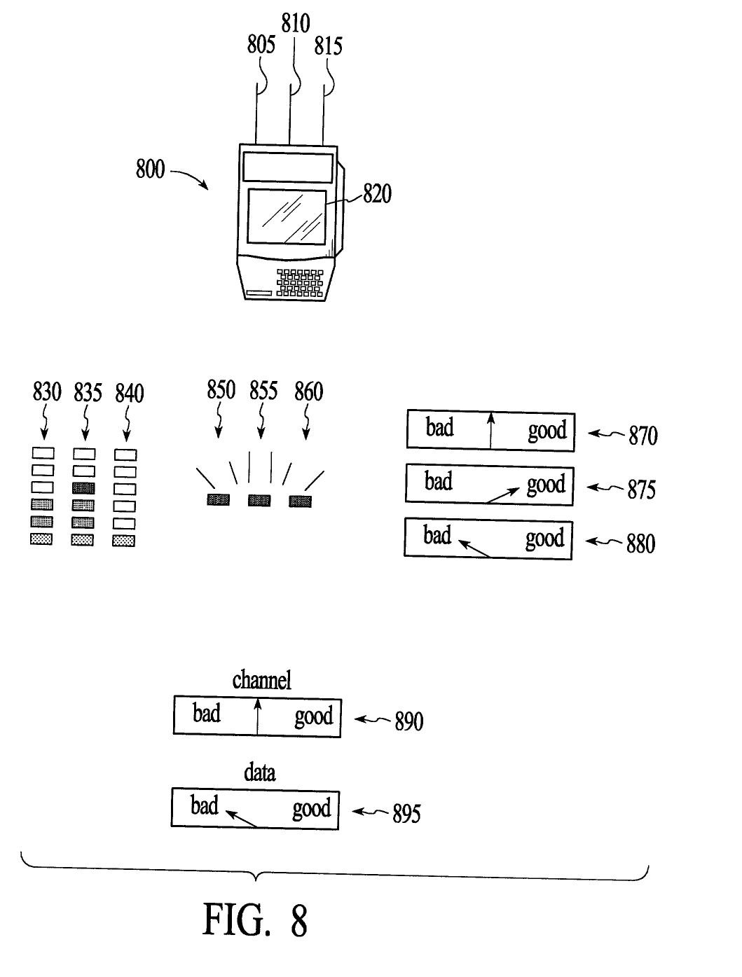

For a further understanding of the display unit, please refer to FIGS. 7 and 8. FIG. 7 is an illustration of a single input display unit 700 and FIG. 8 is an illustration of a multiple input display unit 800.

The single input display unit 700 comprises means for receiving a single input of quality information 710 and a display area 720 for displaying the quality of the wireless data transmission based on a single output implementation.

Also shown in FIG. 7 are contemplated means for displaying the quality of the wireless data transmission based on a single output implementation. Firstly, a single series of light emitting diode (LED) indicators 730 could be used to indicate the quality of the wireless data transmission wherein the number of lit LED's indicates the relative quality of the transmission, e.g. one lit LED signifies a low quality whereas 6 lit LED's signifies a high quality.

Secondly, a single blinking LED 740 could be used to indicate the quality of the wireless data transmission wherein the flashing rate of the LED is indicative of the quality of the wireless data transmission e.g. a slower flashing rate signifies a low quality whereas a higher flashing rate signifies a high quality.

Lastly, a meter 750 (analog or digital) could be used to read some measure of the quality of the wireless data transmission, e.g. for a high quality signal, an arrow 755 points toward “good” and for a low quality signal, the arrow 755 points toward “bad”.

The multiple input display unit 800 comprises means for receiving multiple inputs of quality information 805, 810, 815, and a display area 820 for displaying the quality of the wireless transmission based on a multiple output implementation.

Also shown in FIG. 8 are various means for displaying the quality of the wireless data transmission based on a multiple output implementation. Firstly, separate sets of LED indicators 830, 835, 840 could be utilized wherein each of the separate sets of LED indicators 830, 835, 840 corresponds to the quality of the wireless data transmission for each of the data substreams. Alternatively the separate sets of LED indicators 830, 835, 840 could correspond to the relative strength of individual quality parameters, e.g. one set could correspond to the bit error rate, one set could correspond to the signal-to-noise ratio, etc.

Secondly, separate blinking LED's 850, 855, 860 could be utilized wherein each of the separate blinking LED's 850, 855, 860 corresponds to the quality of the wireless data transmission for each of the data substreams. Alternatively, the separate blinking LED's 850, 855, 860 could correspond to the relative strength of individual quality parameters, e.g. one blinking LED could correspond to the frame error rate, one blinking LED could correspond to the number of cyclic redundancy check failures, etc. Again, the flashing rate of the LED is indicative of the relative strength of the individual quality parameter or the quality of the wireless data transmission for each of the data substreams.

Thirdly, multiple meters 870, 875, 880 could be utilized wherein each of the multiple meters 870, 875, 880 corresponds to the quality of the wireless data transmission for each of the data substreams. Alternatively, the multiple meters 870, 875, 880 could correspond to the relative strength of individual quality parameters.

Another contemplated embodiment utilizes two meters 890, 895. The first meter 890 corresponds to the quality of wireless data transmission based on channel parameters e.g. channel condition number, delay spread, time/frequency variance, etc. The second meter 895 corresponds to the quality of the wireless data transmission based on the data parameters e.g. bit error rate, packet error rate, frame error rate, etc. Accordingly, the end user is able to assess the quality of the wireless data transmission based on both the channel parameters and the data parameters.

The above-described invention comprises a method, system and apparatus for displaying the quality of wireless data transmissions in a wireless communication system. The method and system displays information related to the link quality of a wireless data transmission wherein the wireless data transmission is transmitted via multiple antennae. Based on the link quality information, a system user can quickly and easily adjust system settings in order to attain optimal link quality.

Although the present invention has been described in accordance with the embodiments shown, one of ordinary skill in the art will readily recognize that there could be variations to the embodiments and those variations would be within the spirit and scope of the present invention. Accordingly, many modifications may be made by one or ordinary skill in the art without departing from the spirit and scope of the appended claims.

1. A method for displaying a quality of a wireless data transmission comprising:
receiving the wireless data transmission wherein the wireless data transmission originates from multiple transmit antennae;
determining the quality of the wireless data transmission based on a quality parameter of the wireless data transmission; and
displaying the quality of the wireless data transmission.

2. The method of claim 1 wherein the wireless data transmission comprises multiple streams of data and determining the quality of the wireless data transmission based on a quality parameter of the wireless data transmission comprises:
determining a value of the quality parameter for each of the multiple streams of data.

3. The method of claim 1 wherein the wireless data transmission comprises multiple streams of data and determining the quality of the wireless data transmission based on a quality parameter of the wireless transmission comprises:
determining an aggregate value of the quality parameter for the multiple streams of data.

4. The method of claim 2 wherein the quality parameter is selected from a group consisting of a bit error rate, a packet error rate and a frame error rate.

5. The method of claim 3 wherein the quality parameter is selected from a group consisting of a bit error rate, a packet error rate and a frame error rate.

6. The method of claim 2 wherein the quality parameter is selected from a group consisting of a signal-to-noise ratio, a carrier-to-interference ratio and a signal-to-interference plus noise ratio.

7. The method of claim 3 wherein the quality parameter is selected from a group consisting of a signal-to-noise ratio, a carrier-to-interference ratio and a signal-to-interference plus noise ratio.

8. The method of claim 2 wherein the quality parameter comprises the number of cyclic redundancy check failures.

9. The method of claim 3 wherein the quality parameter comprises the number of cyclic redundancy check failures.

10. The method of claim 1 wherein the wireless data transmission comprises multiple streams of data and determining the quality of the wireless data transmission based on a quality parameter of the wireless data transmission comprises:
determining a propagation channel for the wireless data transmission; and
determining a value for the quality parameter based on the propagation channel.

11. The method of claim 10 wherein the quality parameter is selected from a group consisting of a bit error rate of each of the multiple streams of data, a packet error rate of each of the multiple streams of data, a frame error rate of each of the multiple streams of data.

12. The method of claim 10 wherein the quality parameter is selected from a group consisting of a bit error rate of the multiple streams of data, a packet error rate of the multiple streams of data, a frame error rate of the multiple streams of data.

13. The method of claim 10 wherein the quality parameter is selected from a group consisting of a signal-to-noise ratio of each of the multiple streams of data, a carrier-to-noise ratio of each of the multiple streams of data, and a signal-to-interference plus noise ratio of each of the multiple streams of data.

14. The method of claim 10 wherein the quality parameter is selected from a group consisting of a signal-to-noise ratio of the multiple streams of data, a carrier-to-noise ratio of the multiple streams of data, and a signal-to-interference plus noise ratio of the multiple streams of data.

15. The method of claim 10 wherein the quality parameter is selected from a group consisting of a channel condition number, a delay spread, a time variance, and a frequency variance.

16. A method for displaying a quality of a wireless data transmission comprising:
receiving the wireless data transmission wherein the wireless data transmission originates from a communication system comprising multiple transmit antennae and multiple receive antennae;
determining the quality of the wireless data transmission based on a quality parameter of the wireless data transmission; and
displaying the quality of the wireless data transmission.

17. The method of claim 16 wherein the wireless data transmission comprises multiple streams of data and determining the quality of the wireless data transmission based on a quality parameter of the wireless data transmission comprises:
determining a value of the quality parameter for each of the multiple streams of data.

18. The method of claim 16 wherein the wireless data transmission comprises multiple streams of data and determining the quality of the wireless data transmission based on a quality parameter of the wireless transmission comprises:
determining an aggregate value of the quality parameter for the multiple streams of data.

19. The method of claim 17 wherein the quality parameter is selected from a group consisting of a bit error rate, a packet error rate and a frame error rate.

20. The method of claim 18 wherein the quality parameter is selected from a group consisting of a bit error rate, a packet error rate and a frame error rate.

21. The method of claim 17 wherein the quality parameter is selected from a group consisting of a signal-to-noise ratio, a carrier-to-interference ratio and a signal-to-interference plus noise ratio.

22. The method of claim 18 wherein the quality parameter is selected from a group consisting of a signal-to-noise ratio, a carrier-to-interference ratio and a signal-to-interference plus noise ratio.

23. The method of claim 17 wherein the quality parameter comprises the number of cyclic redundancy check failures.

24. The method of claim 18 wherein the quality parameter comprises the number of cyclic redundancy check failures.

25. The method of claim 16 wherein the wireless data transmission comprises multiple streams of data and determining the quality of the wireless data transmission based on a quality parameter of the wireless data transmission comprises:
determining a propagation channel for the wireless data transmission; and
determining a value for the quality parameter based on the propagation channel.

26. The method of claim 25 wherein the quality parameter is selected from a group consisting of a bit error rate of each of the multiple streams of data, a packet error rate of each of the multiple streams of data, a frame error rate of each of the multiple streams of data.

27. The method of claim 25 wherein the quality parameter is selected from a group consisting of a bit error rate of the multiple streams of data, a packet error rate of the multiple streams of data, a frame error rate of the multiple streams of data.

28. The method of claim 25 wherein the quality parameter is selected from a group consisting of a signal-to-noise ratio of each of the multiple streams of data, a carrier-to-noise ratio of each of the multiple streams of data, and a signal-to-interference plus noise ratio of each of the multiple streams of data.

29. The method of claim 25 wherein the quality parameter is selected from a group consisting of a signal-to-noise ratio of the multiple streams of data, a carrier-to-noise ratio of the multiple streams of data, and a signal-to-interference plus noise ratio of the multiple streams of data.

30. The method of claim 25 wherein the quality parameter is selected from a group consisting of a channel condition number, a delay spread, a time variance, and a frequency variance.

31. A method for displaying a quality of a wireless data transmission comprising:
receiving the wireless data transmission wherein the wireless data transmission originates from a spatial multiplexing system;
determining the quality of the wireless data transmission based on a quality parameter of the wireless data transmission; and
displaying the quality of the wireless data transmission.

32. The method of claim 31 wherein the wireless data transmission comprises multiple streams of data and determining the quality of the wireless data transmission based on a quality parameter of the wireless data transmission comprises:
determining a value of the quality parameter for each of the multiple streams of data.

33. The method of claim 31 wherein the wireless data transmission comprises multiple streams of data and determining the quality of the wireless data transmission based on a quality parameter of the wireless transmission comprises:
determining an aggregate value of the quality parameter for the multiple streams of data.

34. The method of claim 32 wherein the quality parameter is selected from a group consisting of a bit error rate, a packet error rate and a frame error rate.

35. The method of claim 32 wherein the quality parameter is selected from a groups consisting of a bit error rate, a packet error rate and a frame error rate.

36. The method of claim 32 wherein the quality parameter is selected from a group consisting of a signal-to-noise ratio, a carrier-to-interference ratio and a signal-to-interference plus noise ratio.

37. The method of claim 33 wherein the quality parameter is selected from a group consisting of a signal-to-noise ratio, a carrier-to-interference ratio and a signal-to-interference plus noise ratio.

38. The method of claim 32 wherein the quality parameter comprises the number of cyclic redundancy check failures.

39. The method of claim 33 wherein the quality parameter comprises the number of cyclic redundancy check failures.

40. The method of claim 31 wherein the wireless data transmission comprises multiple streams of data and determining the quality of the wireless data transmission based on a quality parameter of the wireless data transmission comprises:
determining a propagation channel for the wireless data transmission; and
determining a value for the quality parameter based on the propagation channel.

41. The method of claim 40 wherein the quality parameter is selected from a group consisting of a bit error rate of each of the multiple streams of data, a packet error rate of each of the multiple streams of data, a frame error rate of each of the multiple streams of data.

42. The method of claim 40 wherein the quality parameter is selected from a group consisting of a bit error rate of the multiple streams of data, a packet error rate of the multiple streams of data, a frame error rate of the multiple streams of data.

43. The method of claim 40 wherein the quality parameter is selected from a group consisting of a signal-to-noise ratio of each of the multiple streams of data, a carrier-to-noise ratio of each of the multiple streams of data, and a signal-to-interference plus noise ratio of each of the multiple streams of data.

44. The method of claim 40 wherein the quality parameter is selected from a group consisting of a signal-to-noise ratio of the multiple streams of data, a carrier-to-noise ratio of the multiple streams of data, and a signal-to-interference plus noise ratio of the multiple streams of data.

45. The method of claim 40 wherein the quality parameter is selected from a group consisting of a channel condition number, a delay spread, a time variance, and a frequency variance.

46. An apparatus for displaying the quality of a wireless data transmission comprising:
means for receiving the wireless data transmission wherein the wireless data transmission originates from multiple transmit antennae;
means for determining the quality of the wireless data transmission based on a quality parameter of the wireless data transmission; and
means for displaying the quality of the wireless data transmission.

47. The apparatus of claim 46 wherein the wireless data transmission comprises multiple streams of data and the means for determining the quality of the wireless data transmission based on a quality parameter of the wireless data transmission further comprises:
means for determining a value of the quality parameter for each of the multiple streams of data transmission.

48. The apparatus of claim 46 wherein the means for determining the quality of the wireless data transmission based on a quality parameter of the wireless data transmission further comprises:
means for determining an aggregate value of the quality parameter for the multiple streams of data.

49. The apparatus of claim 47 wherein the means for displaying the quality of the wireless transmission comprises means for displaying the value.

50. The apparatus of claim 48 wherein means for displaying the quality of the wireless transmission comprises means for displaying the aggregate value.

51. The apparatus of claim 49 wherein the means for displaying the value comprises LED indicators.

52. The apparatus of claim 49 wherein the means for displaying the value comprises an analog meter.

53. The apparatus of claim 50 wherein the means for displaying the value comprises separate sets of LED indicators wherein each of the separate sets of LED indicators corresponds to each of the multiple streams of data.

54. The apparatus of claim 50 wherein the means for displaying the aggregate value comprises an analog meter.

55. The apparatus of claim 49 wherein the quality parameter comprises a channel quality parameter and a data quality parameter and the means for displaying the value of the quality parameter comprises a first and second analog meter wherein the first analog meter displays the value of the channel quality parameter and the second analog meter displays the value of the data quality parameter.

56. The apparatus of claim 49 wherein the quality parameter comprises a channel quality parameter and a data quality parameter and the means for displaying the value of the quality parameter comprises a first and second set of LED indicators wherein the first set of LED indicators corresponds to the channel quality parameter and the second set of Led indicators corresponds to the data quality parameter.

57. A wireless communication system comprising:
a base transceiver station wherein the base transceiver station includes a multiple transmit antennae array;
means for receiving a wireless data transmission from the multiple transmit antennae array;
means for determining a quality of the wireless data transmission based on a quality parameter of the wireless data transmission; and
means for displaying the quality of the wireless data transmission.

58. The system of claim 57 wherein the wireless data transmission comprises multiple streams of data and the means for determining the quality of the wireless data transmission based on a quality parameter of the wireless data transmission comprises:
means for determining a value of the quality parameter for each of the multiple streams of data.

59. The system of claim 57 wherein the wireless data transmission comprises multiple streams of data and the means for determining the quality of the wireless data transmission based on a quality parameter of the wireless transmission comprises:
means for determining an aggregate value of the quality parameter for the multiple streams of data.

60. The system of claim 58 wherein the quality parameter is selected from a group consisting of a bit error rate, a packet error rate and a frame error rate.

61. The system of claim 59 wherein the quality parameter is selected from a group consisting of a bit error rate, a packet error rate and a frame error rate.

62. The system of claim 58 wherein the quality parameter is selected from a group consisting of a signal-to-noise ratio, a carrier-to-interference ratio and a signal-to-interference plus noise ratio.

63. The system of claim 59 wherein the quality parameter is selected from a group consisting of a signal-to-noise ratio, a carrier-to-interference ratio and a signal-to-interference plus noise ratio.

64. The system of claim 58 wherein the quality parameter comprises the number of cyclic redundancy check failures.

65. The system of claim 59 wherein the quality parameter comprises the number of cyclic redundancy check failures.

66. The system of claim 57 wherein the wireless data transmission comprises multiple streams of data and the means for determining the quality of the wireless data transmission based on a quality parameter of the wireless data transmission comprises:
means for determining a propagation channel for the wireless data transmission; and
means for determining a value for the quality parameter based on the propagation channel.

67. The system of claim 66 wherein the quality parameter is selected from a group consisting of a bit error rate of each of the multiple streams of data, a packet error rate of each of the multiple streams of data, a frame error rate of each of the multiple streams of data.

68. The system of claim 66 wherein the quality parameter is selected from a group consisting of a bit error rate of the multiple streams of data, a packet error rate of the multiple streams of data, a frame error rate of the multiple streams of data.

69. The system of claim 66 wherein the quality parameter is selected from a group consisting of a signal-to-noise ratio of each of the multiple streams of data, a carrier-to-noise ratio of each of the multiple streams of data, and a signal-to-interference plus noise ratio of each of the multiple streams of data.

70. The system of claim 66 wherein the quality parameter is selected from a group consisting of a signal-to-noise ratio of the multiple streams of data, a carrier-to-noise ratio of the multiple streams of data, and a signal-to-interference plus noise ratio of the multiple streams of data.

71. The system of claim 66 wherein the quality parameter is selected from a group consisting of a channel condition number, a delay spread, a time variance, and a frequency variance.

72. A wireless communication system comprising:
a base transceiver station wherein the base transceiver station includes a multiple transmit antennae array;
a multiple receive antennae array for receiving a wireless data transmission from the multiple transmit antennae array;
means for determining a quality of the wireless data transmission based on a quality parameter of the wireless data transmission; and
means for displaying the quality of the wireless data transmission.

73. A wireless communication system comprising:
a base transceiver station wherein the base transceiver station implements a spatial multiplexing technology;
means for receiving a wireless data transmission from the base station;
means for determining a quality of the wireless data transmission based on a quality parameter of the wireless data transmission; and
means for displaying the quality of the wireless data transmission.
